(19) United States
(12) Patent Application Publication
(10) Pub. No.: US 2013/0227791 A1
(43) Pub. Date: Sep. 5, 2013

(54) PORTABLE CONVEYING DEVICE FOR PATIENTS

(71) Applicant: KAERCHER FUTURETECH GMBH, Schwaikheim (DE)

(72) Inventors: Markus Kostron, Remseck (DE); Markus Kurt Saygin, Berlin (DE); Manuela Braeuning, Winnenden (DE)

(73) Assignee: Kaercher Futuretech GmbH, Schwaikheim (DE)

(21) Appl. No.: 13/865,462

(22) Filed: Apr. 18, 2013

Related U.S. Application Data
(63) Continuation of application No. PCT/EP2011/067693, filed on Oct. 11, 2011.

(30) Foreign Application Priority Data
Oct. 22, 2010 (DE) 10 2010 050 450.5

(51) Int. Cl. A61G 1/01

(52) U.S. Cl. CPC A61G 1/01
USPC 5/629

(57) ABSTRACT

A portable conveying device for patients who are heavily soiled or chemically, biologically or radioactively contaminated. The device comprises a mechanically flexible rescue sheet, wherein said rescue sheet has a top face that defines a lying surface for receiving a patient in a lying position and an underside opposite the top face. The device further comprises a mechanically flexible underlay sheet that is chemically resistant and impermeable to liquid. The underlay sheet at least partially covers the underside of the rescue sheet and is releasably connected thereto, such that the underlay sheet may in its entirety be disconnected from the rescue sheet and a patient may be carried away with the rescue sheet only.

### CROSSREFERENCES TO RELATED APPLICATIONS

This application is a continuation of international patent application PCT/EP2011/067693, filed on Oct. 11, 2011 designating the U.S., which international patent application has been published in German language and claims priority from German patent application 10 2010 050 450.5, filed on Oct. 22, 2010. The entire contents of these priority applications are incorporated herein by reference.

### BACKGROUND OF THE INVENTION

The disclosure relates to a portable conveying device for patients. In particular, the disclosure relates to a portable conveying device for patients who are heavily soiled, soaked through and/or are chemically, biologically or radioactively contaminated.

Conveying devices of this kind are used particularly for rescuing and transporting patients who, for example as a result of an accident involving hazardous materials, are heavily soiled or are even chemically, biologically or radioactively contaminated. In such cases, there are strict requirements concerning the care of the patient. Firstly, in order to protect the patient, it is in most cases necessary that the patient is cleaned or decontaminated as far as possible at the place of the accident. Secondly, one of the most important requirements in such cases is to avoid extending the contaminated area beyond the site of the accident. In this connection, mention is often made of the need to suppress, as far as possible, any spread of contamination.

In accidents of this kind, special conveying devices are therefore needed which, in addition to the actual conveying function, also perform many other functions. For example, the conveying device should allow a patient positioned on the conveying device to be cleaned or decontaminated as easily and as thoroughly as possible. Moreover, the conveying device often has to be used on rough terrain where there is limited space. Conventional stretchers of the kind known from the prior art are often unsuitable in situations where space is limited, since they are too cumbersome and take up too much room. For uses on rough terrain where space is confined, it has therefore proven advantageous to use mechanically flexible and lightweight rescue sheets. These are not only space-saving, they can also be used in a versatile way allowing them to be easily adapted to the environmental conditions. Their foldable properties mean that they take up only little room when folded up, which is why they can be conveyed to the accident location much more easily than conventional stretchers. Moreover, these rescue sheets also have a much lower weight. In addition, compared to the use of a conventional stretcher, a patient does not have to be lifted in order to be positioned on the lying surface, since these rescue sheets, laid flat on the ground, permit simple positioning of the patient.

A conventional rectangular rescue sheet is known from DE 20 2005 013 832 U1, for example. Furthermore, DE 10 2009 022 853 A1 discloses a rescue sheet having a plurality of strengthening ribs, as a result of which it is especially suitable for conveying heavy individuals. Moreover, DE 10 2006 045 318 A1 discloses a dimensionally flexible conveying device for rescue use, which is suitable in particular for conveying people across water or other fluid surfaces such as mud, snow, ice or sand.

However, the rescue sheets mentioned all have the disadvantage that they satisfy only a few of the abovementioned requirements that apply in the event of an accident involving hazardous material. These rescue sheets only rarely satisfy the important requirement of preventing the spread of contamination, i.e. extension of the contaminated area beyond the site of the accident. Moreover, the known rescue sheets are not very suitable for immediate temporary decontamination of the patient.

Special rescue sheets that are suitable for the uses described above are not known till now.

### SUMMARY OF THE INVENTION

It is therefore an object to provide a portable conveying device which is suitable in particular for rescuing patients who are heavily soiled and/or chemically, biologically or radioactively contaminated, which is mechanically flexible and is suitable for use on rough terrain, especially where space is limited. The conveying device shall as far as possible meet the basic principle of avoiding the spread of contamination. It should also allow the patient to be received on the conveying device even more easily and should facilitate the temporary decontamination of the patient directly at the site of the accident.

In view of this object, there is provided a portable conveying device for patients who are heavily soiled or chemically, biologically or radioactively contaminated, said device comprising a rescue sheet having a mechanically flexible form, wherein said rescue sheet has a top face that defines a lying surface for receiving a patient in a lying position and an underside opposite the top face, facing away from the lying surface. The rescue sheet is a multi-layer sheet having a liquid-absorbing absorber layer and a tear-resistant support layer that defines the underside of the support sheet. The portable conveying device further comprises a covering underlay sheet having a mechanically flexible form and being chemically resistant and impermeable to liquid. The covering underlay sheet covers the underside of the rescue sheet and is releasably connected thereto, such that the covering underlay sheet may in its entirety be disconnected from the rescue sheet and a patient may be carried away with the rescue sheet only.

According to a further aspect, there is provided a portable conveying device for patients who are heavily soiled or chemically, biologically or radioactively contaminated, said device comprising a mechanically flexible rescue sheet, wherein said rescue sheet has a top face that defines a lying surface for receiving a patient in a lying position and an underside opposite the top face. The device further comprises a mechanically flexible underlay sheet that is chemically resistant and impermeable to liquid. The underlay sheet at least partially covers the underside of the rescue sheet and is releasably connected thereto, such that the underlay sheet may in its entirety be disconnected from the rescue sheet and a patient may be carried away with the rescue sheet only.

According to a still further aspect, there is provided a portable conveying device for patients who are heavily soiled or chemically, biologically or radioactively contaminated, said device comprising a mechanically flexible rescue sheet, wherein said rescue sheet has a top face, that defines a lying surface for receiving a patient in a lying position, and an opposite underside. The top face of the rescue sheet is provided with a protective layer which is liquid- and/or gas-permeable in an unidirectional manner, to allow liquid and/or gas to penetrate into an absorber layer that is arranged below the protective layer, and to prevent the liquid and/or the gas from leaving the absorber layer through said protective layer. The device further comprises a mechanically flexible underlay sheet that is impermeable to liquid. The underlay sheet at least partially covers the underside of the rescue sheet and is releasably connected thereto.

The inventors have found that by means of a two-part structure, composed of a mechanically flexible rescue sheet and of a covering underlay arranged on the underside of the rescue sheet, the spread of contamination can be prevented as best as possible. The liquid-impermeable and/or chemically resistant covering underlay, which forms the underside of the conveying device with which the latter is placed on the ground, acts as a barrier for hazardous materials. In the event of an accident involving hazardous materials, where the ground at the site of the accident is often heavily soiled or contaminated, the portable conveying device can thus be placed on the ground without the rescue sheet coming into direct contact with the soiled or contaminated ground. During the fitting of the rescue sheet or during the positioning of a patient on the lying surface of the rescue sheet, the covering underlay thus prevents the hazardous materials from reaching the rescue sheet.

Therefore, the rescue sheet itself is soiled or contaminated only slightly, if at all, by the patient. By virtue of the two-part design of the conveying device, the heavily soiled or contaminated covering underlay sheet can be released from the rescue sheet, such that said covering underlay sheet can be left behind at the site of the accident and the patient is carried off on the rescue sheet. A spread of contamination is thereby reduced to a minimum.

The covering underlay sheet left behind at the site of the accident can then be cleaned separately or, if it is too heavily soiled or contaminated, it can be directly destroyed. Thus, a disposable form and a reusable form of covering underlay sheet are conceivable.

By virtue of the mechanically flexible design of the rescue sheet and also of the covering underlay sheet, it is possible for the portable conveying device to be very easily folded up or rolled up, such that it can be stowed in a format that takes up very little room compared to a conventional, dimensionally stable stretcher. This improves the transportability of the portable conveying device to the accident location. It also ensures that the device can be used without difficulty on rough terrain where space is limited. Moreover, the weight is greatly reduced by comparison with stretchers having dimensionally stable and solid carrier frames.

Although dimensionally flexible rescue sheets of this kind are of a very simple design, they still allow persons to be safely conveyed on them. To additionally safeguard the patient, the portable conveying device comprises a securing means by which the patient positioned on the lying surface is held on the conveying device and protected against falling out. For this purpose, straps or buckles can be provided, by which the patient positioned on the lying surface is at least partially enclosed and is held or fixed on the lying surface.

It will be appreciated that the portable conveying device can be used not just to transport individuals but also to transport materials of all kinds. For example, the conveying device can also be used to carry the necessary tools, for example medical appliances or other necessary equipment, on the way to and from the accident location.

Although the portable and mobile properties of the presented conveying device represent an important feature of the present invention for the reasons set out above, a stationary use of the conveying device is also conceivable without leaving the spirit of the invention.

In a refinement, a plurality of releasable securing elements, in particular press studs, hook-and-loop fasteners, zippers or releasable adhesive connections, are arranged at circumferential spaced-apart securing points in the area of the outer edge of the rescue sheet and/or of the covering underlay sheet.

These securing elements ensure the releasable connection between the rescue sheet and the covering underlay sheet. Since the securing elements are arranged at circumferential securing points in the area of the outer edge of the rescue sheet and/or of the covering underlay sheet, they are readily accessible, such that the covering underlay sheet can be easily released from the rescue sheet. The securing elements are preferably designed with a small surface area and are spaced apart from one another, such that spaces are present between them which allow the helpers to easily grip the device in order to remove the covering underlay sheet. The spaces are preferably large enough to ensure that the helpers can place their hands into them. A sufficient distance between the securing points is therefore advantageous.

In addition to the securing possibilities already mentioned, other securing elements are also conceivable which produce a releasable connection between rescue sheet and covering underlay sheet. For example, a Velcro® fastener or a releasable adhesive connection is also conceivable, for example of the kind used in the Post-it® developed by 3M.

Preferably, the securing elements can be easily detached and also easily reconnected to one another. In this way, the covering underlay sheet can be easily released from the rescue sheet and left behind at the site of the accident. However, in the case of a re-usable variant, it can easily be reconnected to the rescue sheet after being cleaned, such that it is ready to be used again.

In another refinement, the rescue sheet is designed in several layers as a multi-layer sheet, with a liquid-absorbing and/or liquid-binding absorber sheet layer and a tear-resistant support layer.

The support layer is preferably designed to be liquid-impermeable and/or gas-impermeable and has several carrying handles for carrying the conveying device.

By means of such a structure of the rescue sheet, it is possible to more effectively prevent the spread of contamination. The absorber layer sucks up, and binds within it, much of the contaminated liquid still present on the patient when the latter is positioned on the lying surface. The absorber layer thus permits a first temporary decontamination of the patient directly on site, since it soaks up the substances adhering to the patient, diverts them from the lying surface and the patient and finally binds them in its interior. Moreover, the tear-resistant, liquid-impermeable and/or gas-impermeable support layer prevents escape of the contaminated liquids or of the hazardous substances from the rescue sheet, even when the covering underlay has already been detached. Spread of the hazardous substances beyond the site of the accident is accordingly avoided. By means of the absorbing and binding function of the absorber layer, the rescue sheet can also be used to transport leaking drums, containers, or other soiled or contaminated items, without this causing spread of contamination.

In a further refinement, the absorber layer forms the top face of the rescue sheet defining the lying surface, and the support layer forms the underside of the rescue sheet. A patient positioned on the lying surface thus comes directly into contact with the absorber layer, which soaks up and binds within it the liquids adhering to the patient. For this purpose, the absorber layer preferably contains an absorbent granulate which, as in diapers for babies, can absorb a large amount of liquid and prevent reemergence from the absorber layer. For this purpose, the absorber inside the absorber layer is preferably a superabsorbent. Such plastics known as superabsorbents are able to absorb liquid by a multiple of their inherent weight, up to 1000 times the latter. They are mostly used in the form of coarse-grained powder.

To satisfy the abovementioned functions, the absorber layer preferably has a multi-layer structure, with a liquid-absorbing absorption layer and a liquid-binding binder layer.

As it has been described, an absorber layer of this kind ensures the absorption of aqueous, oily and in particular also aggressive toxic or pathogenic liquids and also dusts or dry hazardous materials and thus permits a temporary decontamination of the patient. By means of the absorbent action of the absorber layer, the surface (the top face) of the rescue sheet remains dry, which additionally contributes to the protection and comfort of the patient. The absorber layer can also be designed for this purpose in the form of a liquid-absorbing nonwoven, into which the absorber agent is incorporated or onto which it is applied. Such a nonwoven also provides the patient with a soft and comfortable support.

Moreover, the multi-layer structure of absorber layer and support layer of the rescue sheet also affords the advantage that the double layer has an insulating action and thus also protects the patient from heat or cold. In addition, the multi-layer structure also acts as protection against impacts during transport. This is of particular advantage especially in confined spaces, on uneven terrain, or at accident sites where pieces of wreckage or rubble are lying around.

In another refinement, the top face of the rescue sheet defining the lying surface is additionally provided with a protective layer which is liquid-permeable and/or gas-permeable in an unidirectional manner to allow liquid and/or gas to penetrate into the absorber layer and to prevent the liquid and/or the gas from leaving the absorber layer through the protective layer.

A protective layer of this kind, which is stretched across the absorber layer, additionally prevents the liquids taken up by the absorber layer from escaping again at the top face of the rescue sheet and thus coming into contact again with the patient. It thus additionally ensures that the lying surface of the rescue sheet on which the patient comes to lie is continuously dry. The liquids, or possibly also the dangerous gases, can penetrate through the protective layer into the absorber layer arranged between the protective layer and the support layer and then no longer come into contact with the patient. This not only increases the level of protection of the patient but also more effectively prevents the risk of spread of contamination.

In another refinement, a chemical-resistant and/or temperature-resistant barrier layer is arranged between the absorber layer and the support layer.

This barrier layer is preferably highly resistant to chemicals and impermeable to hazardous substances. It even more effectively prevents the spread of contamination since, even after the covering underlay has been taken off and left behind at the accident location, the rescue sheet is still leaktight. Moreover, it not only increases the leaktightness of the rescue sheet but also prevents the often highly toxic hazardous substances from eating their way through the rescue sheet and destroying the latter and thus making it unfit for use. The barrier layer thus also improves the robustness of the rescue sheet.

In another refinement, the portable conveying device has a mechanically flexible, foldable cover sheet which, in the folded state, is fixed on the rescue sheet, in particular by a hook-and-loop fastener or a zipper, and, in the unfolded state, at least partially covers a patient positioned on the lying surface.

The cover sheet also serves to protect the patient and can be used to dab the patient clean. Dabbing the patient with the cover sheet thus permits a temporary decontamination directly at the accident location.

Since the cover sheet is foldable and, in the folded state, can be fixed on the rescue sheet, it can, if necessary, be stowed in a manner that takes up little space. This possibility of space-saving storage of the cover sheet proves advantageous in the rescuing of the patient. This is because the cover sheet is not in the way when the rescue sheet is placed on the patient, such that it does not limit or impede the space available for the rescuers to work in and makes it easier to position the patient on the rescue sheet.

It is particularly advantageous if the cover sheet can be folded up and unfolded in the manner of a concertina. To avoid spreading contamination, it is advantageous that the rescue sheet also has a liquid-absorbing or liquid-binding action.

It is therefore preferable, according to a further refinement of the invention, if the cover sheet is designed in several layers, with a liquid-binding absorber layer and with a protective layer which is liquid-permeable and/or gas-permeable on one side.

For this purpose, the liquid-binding absorber layer, in the unfolded state, is preferably directed away from the patient positioned on the lying surface and it thus forms the top of the cover sheet. By contrast, in the unfolded state, the protective layer made liquid-permeable and/or gas-permeable on one side is preferably directed toward the patient positioned on the lying surface and it thus forms the inside of the cover sheet. This protective layer allows liquid and/or gas to penetrate into the absorber layer but prevents the liquid and/or gas from escaping again from the absorber layer through the protective layer. It is therefore only liquid-permeable and/or gas-permeable in an unidirectional manner.

Similarly to the above-described structure of the rescue sheet, the structure of the cover sheet also has a multi-layer design. As soon as a patient is positioned on the lying surface, the cover sheet can be very easily unfolded and used to dab the patient clean. The liquid or the gas can pass or diffuse through the protective layer into the absorber layer. As has already been indicated, such an absorber layer preferably contains an effective absorber that soaks up and permanently binds the liquids or gases.

Therefore, dabbing the patient with the cover sheet not only helps avoid the spread of contamination but also frees the patient from the often corrosive liquids and thus contributes to protecting the patient.

In another refinement, the top face of the cover sheet is additionally provided with a liquid-repelling covering layer.

A covering layer of this kind, which in the unfolded state of the cover sheet forms the top face directed away from the patient, i.e. the outer envelope of the cover sheet, shields the cover sheet and therefore also the patient from the outside. It has a liquid-repelling action and thus ensures, e.g. even when it is raining, that the patient lying on the conveying device is dry. Moreover, in the unfolded state of the cover sheet, it shields the lying surface, and therefore also the patient, from polluted or also chemically, biologically or radioactively contaminated liquids or gases.

According to a further refinement, the cover sheet is designed in two parts, wherein the two parts of the cover sheet are each arranged on opposite lengthwise sides of the rescue sheet and are fixedly connected to the rescue sheet.

Therefore, if the cover sheet is not required, it can be folded up and stowed on the lengthwise edge of the rescue sheet. In the unfolded state, the two parts of the cover sheet can preferably be connected to each other by a hook-and-loop fastener or a zipper, such that a patient positioned on the lying surface is at least partially enclosed by the cover sheet. The cover sheet is thus placed like a jacket or a cape over the patient and can be closed. In the closed state of the cover sheet, therefore, the cover sheet forms, together with the rescue sheet, an at least partially closed space for the patient. This additionally secures the patient on the conveying device and protects him from any liquids or gases from the outside.

Preferably, in the area of the head and in the area of the feet, the cover sheet also has additional pockets which protect the head or feet of the patient. These pockets are preferably removable from the rescue sheet and can be adjusted in their lengthwise position, so as to be able to adapt them to patients of different sizes. They additionally protect the patient from sliding out of the conveying device.

In another refinement, at least one of the parts of the cover sheet is turned over the lying surface on one of the lengthwise sides of the rescue sheet and thereby forms, with the lying surface, a pocket-shaped recess extending in the longitudinal direction of the rescue sheet.

This recess serves in particular for positioning the conveying device when placing the patient on it. In the case of a patient lying on the ground, one seeks in practice to push the conveying device as close as possible to the patient on the ground. The patient is mostly located in the stable side position. Said pocket-shaped recess allows the rescuers to very easily find a hold inside the conveying device or inside the rescue sheet, in order to push the rescue sheet as close as possible up to the patient's back or even under the patient. The patient is then rolled onto his back about the longitudinal axis of his body, such that he comes to lie on the lying surface of the rescue sheet. The rescuers can then once again use the pocket-shaped recess to pull the rescue sheet back to the correct position under the patient.

Instead of a pocket-shaped recess, pulling belts are also conceivable which are fitted on the conveying device and with which the conveying device can be very easily pulled along the ground to the patient and/or pulled under him. It is also conceivable that the described securing straps for securing the patient on the lying surface can serve as pulling belts of this kind.

In another refinement, the underside of the covering underlay directed away from the lying surface has a smooth surface, in particular made of plastic.

A smooth surface of this kind preferably has a low degree of roughness and, on asphalt, a low coefficient of sliding friction. This makes it considerably easier to move, in particular to push or slide, the conveying device on the ground. In particular, this proves to be a huge advantage in placing the rescue sheet on the patient and in establishing transportability.

In another refinement, the covering underlay is at least partially surrounded at its outer edge by a liquid-absorbing and liquid-binding barrier element, in particular of nonwoven fabric, wherein the barrier element has a bead-shaped design and is fixedly connected to the covering underlay.

The bead-shaped barrier element in turn serves to protect the lying surface of the rescue sheet. The conveying device can thus also be placed in a puddle of liquid containing polluted or contaminated substances, as is often encountered in accidents involving hazardous substances. The liquid-absorbing and liquid-binding barrier element, which is preferably constructed from a permeable meshwork in which a liquid-absorbing agent is incorporated, effectively prevents entry of the polluted liquid into the conveying device or onto the lying surface. Therefore, even in such an extremely arduous situation as this, the patient is kept safe and dry on the lying surface.

The barrier element is preferably fixedly connected to the covering underlay and, as has been described above, is in practice mostly left behind together with the covering underlay at the site of the accident, in order to avoid the spread of contamination.

In another refinement, the portable conveying device has a securing means, which in particular comprises loops or eyelets through which a carrier frame for carrying the rescue sheet can be fitted releasably on the rescue sheet.

In this way, a carrier frame can be easily fitted on the rescue sheet. By virtue of the releasable connection, the carrier frame can be transported separately and is then fitted only when necessary on the rescue sheet. In particular, the carrier frame affords the advantage of giving the rescue sheet increased stability and making it much easier for the rescuers to carry the rescue sheet and the patient positioned thereon. The rescue sheet can in this way be easily carried or transported by, for example, two persons.

It will be appreciated that the carrier frame itself can be designed in a wide variety of different forms. A foldable and easily stowable carrier frame is particularly preferred.

It will be appreciated that the aforementioned features and the features still to be explained below can be used not only in the respectively indicated combination, but also in other combinations or singly, without departing from the spirit of the present invention.

### BRIEF DESCRIPTION OF THE DRAWINGS

Illustrative embodiments of the invention are explained in more detail in the following description and are depicted in the drawings, in which:

FIG. 1 shows a perspective schematic view of a first illustrative embodiment of the portable conveying device for patients;

FIG. 2 shows a perspective schematic view of the first illustrative embodiment of the conveying device from FIG. 1 with a carrier frame;

FIG. 3 shows a schematic cross section of the first illustrative embodiment of the conveying device from FIG. 1; and

FIG. 4 shows schematic cross-sectional views (A-E) to illustrate the placement of the conveying device on a patient.

### DESCRIPTION OF PREFERRED EMBODIMENTS

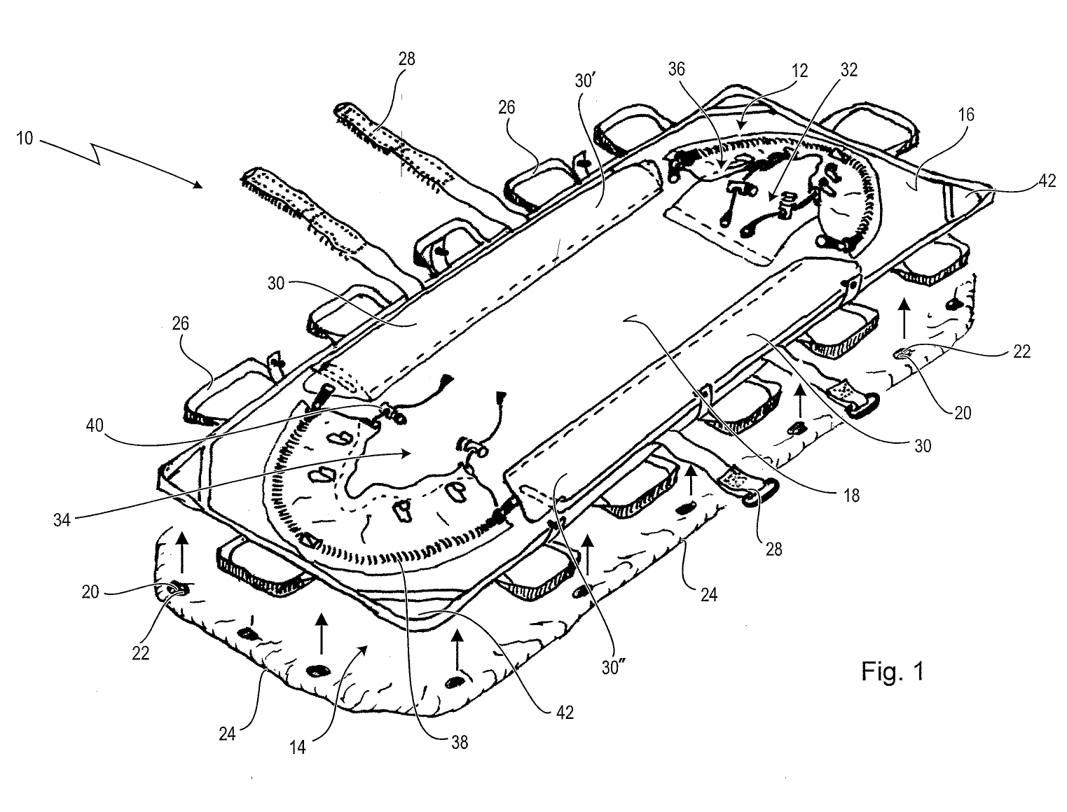

FIG. 1 shows, in a schematic perspective view, a first illustrative embodiment of the novel portable conveying device for patients. In this figure, the portable conveying device is designated in its entirety by the reference number 10. The portable conveying device 10 is designed in two parts and has a mechanically and/or dimensionally flexible rescue sheet 12 and a likewise mechanically and/or dimensionally flexible covering underlay sheet 14, which are connected releasably to each other. The rescue sheet 12 defines, on its top face 16, a lying surface 18 for receiving a patient in a lying position.

The releasable connection between the rescue sheet 12 and the covering underlay 14 is provided by a plurality of releasable securing elements 20, which are preferably designed as press studs, hook-and-loop fasteners, zippers or releasable adhesive connections. These securing elements 20 are arranged on the rescue sheet 12 and on the covering underlay 14 at circumferential securing points 22, which are spaced apart from one another and are located in the area of the outer edge 24 of the rescue sheet 12 and of the covering underlay 14.

To simplify transport, the rescue sheet 12 has a plurality of carrying handles 26 on its lengthwise ends and on its front ends. Moreover, the rescue sheet 12 has a securing means 28 for securing the patient on the conveying device 10. In the present embodiment, this securing means 28 is designed in the form of securing straps by which a patient can be fixed on the lying surface 18.

Moreover, the rescue sheet 12 comprises a mechanically and/or dimensionally flexible, foldable cover sheet 30, which is located in the folded state in the view shown in FIG. 1. The cover sheet 30 is designed in two parts, wherein each of the two parts 30′ and 30″ is connected fixedly to the rescue sheet 12. The two parts 30′, 30″ of the cover sheet 30 are arranged lying opposite each other on both lengthwise sides of the rescue sheet 12. In the unfolded state, the two parts 30′, 30″ are preferably connectable to each other by a hook-and-loop fastener or a zipper. A patient positioned on the lying surface 18 is therefore at least partially enclosed by the cover sheet 30.

The cover sheet 30 serves mainly to protect the patient from liquids and gases, and also from solid hazardous substances in the surrounding area. Moreover, the cover sheet 30 has the function of being able to clean the patient placed on the lying surface 18, in order to help decontaminate said patient at the accident location. If the cover sheet 30 is not needed, it is folded up in the manner of a concertina in order to save space, as is shown in FIG. 1.

To further protect the patient on the rescue sheet 12 in the illustrative embodiment shown, hood-shaped pockets 36 are provided in the head area 32 and in the foot area 34 of the lying surface 18 and receive the head or the feet of the patient. The pockets 36 additionally safeguard the patient against sliding out of the conveying device 10. They are preferably secured releasably on the rescue sheet 12 by a zipper 38 and/or can be positioned adjustably in the longitudinal direction of the rescue sheet 12 in order to adapt them to different sizes of patients. For example, a head pocket and/or foot pocket can be secured movably on a string, which for its part is secured on the rescue sheet 12. The size of the pocket is preferably variable via a quick closure piece 40 which, in the embodiment shown, is in the form of a tensioning cord with cord toggle.

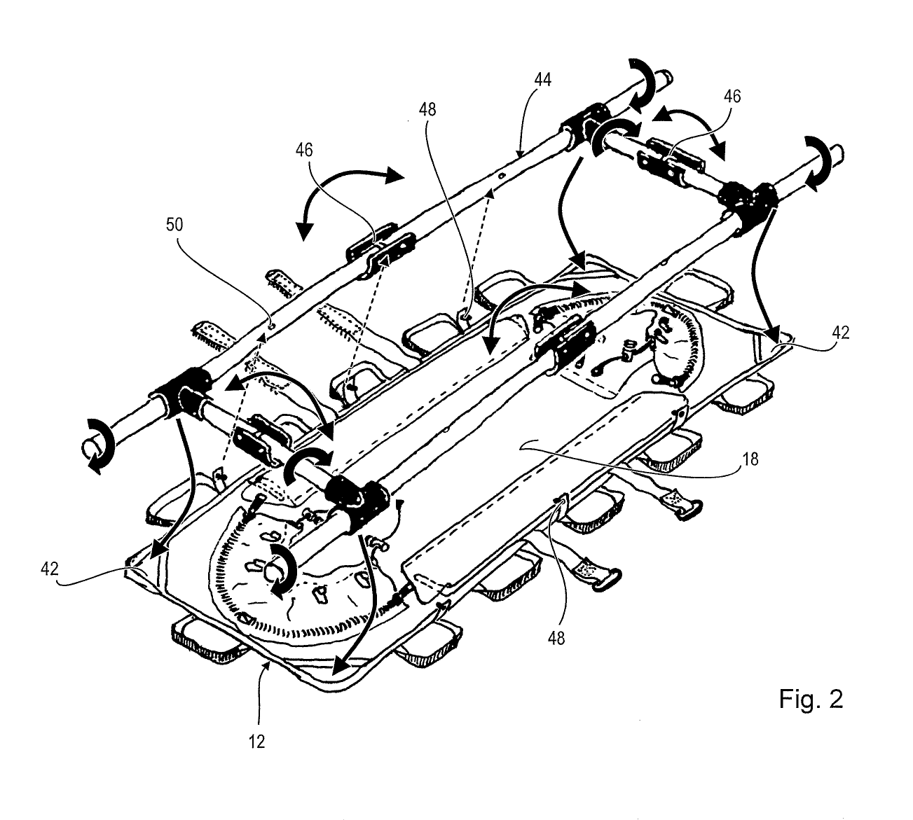

Moreover, the conveying device has a plurality of loops or eyelets 42, which are preferably arranged at the corners of the rescue sheet 12. By means of these loops 42, it is possible, as is shown in FIG. 2, to fit a carrier frame 44 on the rescue sheet 12. The carrier frame 44 makes it easier in particular to carry off a patient positioned on the lying surface 18 and also increases the stability of the rescue sheet 12. So as to be able to be stored in a form that takes up as little space as possible, the carrier frame 44 is preferably designed, as is shown, such that it can be folded up via several hinges 46. The carrier frame 44 can therefore be brought very easily and quickly into its position of use. However, if it is not needed, it can also be folded up in a very compact format by virtue of the hinges 46. For additional securing of the carrier frame 44, a plurality of securing pins 48 are provided on the lengthwise sides of the rescue sheet 12 and engage, in the assembled state, in corresponding bores 50 on the carrier frame.

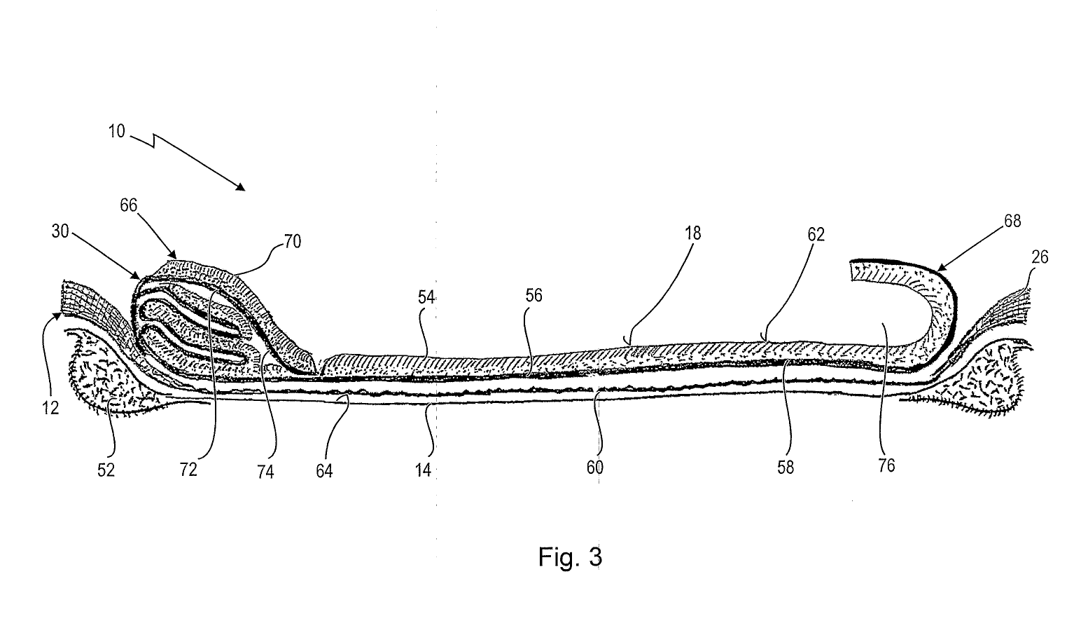

The functional structure of the novel portable conveying device 10 can best be seen from the schematic cross section shown in FIG. 3. As will be apparent from this cross section, the covering underlay sheet 14 forms the underside of the conveying device 10 directed away from the lying surface 18. The covering underlay sheet 14 is liquid-impermeable and/or chemically resistant, such that it shields the conveying device from the underside thereof and ensures that liquids and/or chemicals from the ground do not pass into one of the other layers of the conveying device 10. For additional protection, the covering underlay has, at its outer edge, a liquid-absorbing and liquid-binding barrier element 52. This barrier element preferably has a bead-shaped design and is connected fixedly to the covering underlay 14. The material used for the bead-shaped barrier element 52 is preferably an absorbent nonwoven in which a liquid-absorbing agent is incorporated. By virtue of its bead-shaped design, this absorbent nonwoven 52 can take up a large amount of liquid, such that the rescue sheet 12 is protected on all sides against liquids issuing from the ground. In an accident involving hazardous materials, which often results in contaminated or strongly polluted ground, the conveying device 10 can therefore be placed on the ground without the rescue sheet 12 being soiled or contaminated. In order to avoid the spread of contamination, the rescue sheet 12, with the patient lying on it, is then transported away on its own from the site of the accident, whereas the soiled and contaminated covering underlay 14 remains at the site of the accident. It is thus possible to reduce the spread of contamination to a minimum.

As is shown in FIG. 3, the rescue sheet 12 is composed of several layers. It contains a protective layer 54, which is liquid-permeable and/or gas-permeable in an unidirectional manner, a liquid-binding absorber layer 56, a chemical-resistant and/or temperature-resistant barrier layer 58, and a tear-resistant support layer 60. The protective layer 54 that is liquid-permeable and/or gas-permeable in an unidirectional manner forms the top face 62 of the rescue sheet 12 defining the lying surface 18. Liquid and/or gas can penetrate into the absorber layer 56 through this protective layer 54. It additionally prevents liquid and/or gas from escaping from the absorber layer 56 through the protective layer 54.

The underside 64 of the rescue sheet 12 is formed by the tear-resistant support layer 60. The support layer 60 is preferably liquid-impermeable and/or gas-impermeable. The carrying handles 26 already described above are arranged laterally on the support layer 60. The support layer 60 mainly ensures mechanical stability of the rescue sheet 12 and, by way of the carrying handles 26, allows the conveying device 10 to be carried and the patient to be safely lifted.

Between the protective layer 54 and the support layer 60, the absorber layer 56 is arranged adjoining the protective layer 54, and the barrier layer 58 is arranged adjoining the support layer. The absorber layer 56 preferably has a liquid-binding absorber agent incorporated in it. This absorber agent is preferably a superabsorbent. The absorber layer 56 in this way acts like a baby's diaper and ensures immediate absorption of aqueous and oily, in particular also aggressive toxic or also pathogenic liquids. The barrier layer 58 lying below it has a high degree of chemical resistance and is impermeable to hazardous substances. It prevents the spread of contamination since, even after the covering underlay 14 has been removed, it ensures a high degree of sealing of the rescue sheet 12 and thus avoids seepage of the hazardous substances through the rescue sheet during transport.

FIG. 3 also shows the cover sheet 30 in cross section. In the embodiment shown, it is in two parts, namely a first part 66 and a second part 68. The two parts 66, 68 of the cover sheet 30 are each arranged on opposite lengthwise sides of the rescue sheet 12 and are preferably fixedly connected to the latter. In the embodiment shown, the rescue sheet 12 merges directly at its lengthwise sides into the cover sheet 30. The first part 66 of the cover sheet 30 is shown in the folded state in FIG. 3. This folded state corresponds to the state when the rescue sheet 12 is placed on the patient, i.e. prior to its use. When the cover sheet 30 is in use, it can be folded out like a concertina in order to at least partially cover the patient positioned on the lying surface. The sense and purpose of the cover sheet 30 is to afford the possibility of using it to dab the patient clean and thus go at least some way to decontaminating said patient at the accident site.

In the unfolded state, the two parts 66, 68 of the cover sheet 30 can be connected to each other, in particular by a hook-and-loop fastener or a zipper, such that a patient positioned on the lying surface 18 is at least partially enclosed by the cover sheet 30. In this way, the cover sheet 30 acts similarly to a jacket or sack surrounding the patient and protecting him from the outside.

To permit the best possible cleaning function, the cover sheet 30, like the rescue sheet 12, is preferably composed of several layers. It has a protective layer 70, which is liquid-permeable and/or gas-permeable on one side, a liquid-binding absorber layer 72, and a covering layer 74. In the unfolded state, the protective layer 70 that is liquid-permeable and/or gas-permeable on one side is directed toward the patient positioned on the lying surface 18 and thus forms the inside of the cover sheet 30. It allows entry of liquid and/or gas into the absorber layer 72, which is arranged between the protective layer 70 and the covering layer 74. At the same time, the protective layer 70 prevents the liquid and/or gas from escaping from the absorber layer 72. The absorber layer 72 incorporated between the two other layers 70, 74 serves principally to absorb liquid. When the patient is being dabbed dry, the absorber layer 72 soaks up and binds within it much of the liquid adhering to the patient. To achieve the best possible absorbency and good liquid-binding properties, this absorber layer is preferably made from a nonwoven, with an absorber material incorporated therein. The covering layer 74 serves principally as a liquid-repelling protective layer, which prevents liquid entering the absorber layer 72 from the outside. In the unfolded state of the cover sheet 30, said covering layer is directed away from the patient positioned on the lying surface 18 and, in this state, thereby forms the upper and outer face of the cover sheet 30.

In the embodiment shown in FIG. 3, the second part 68 of the cover sheet 30 arranged on the opposite lengthwise side of the rescue sheet 12 is substantially shorter. It will be appreciated, however, that this second part 68 can also be designed with the same length as the first part 66 of the cover sheet and can likewise be folded up. However, the second part 68 of the cover sheet 30, being of a shorter length in this embodiment, has a further auxiliary use here. It is turned partly over the lying surface 18, as a result of which it forms, with the lying surface 18, a recess 76 extending in the longitudinal direction of the rescue sheet 12. This recess 76 is large enough to allow the helpers to put their hands into it. In this way, the conveying device 10 can be very easily pulled and pushed on the ground and brought into the correct position for placing on the patient.

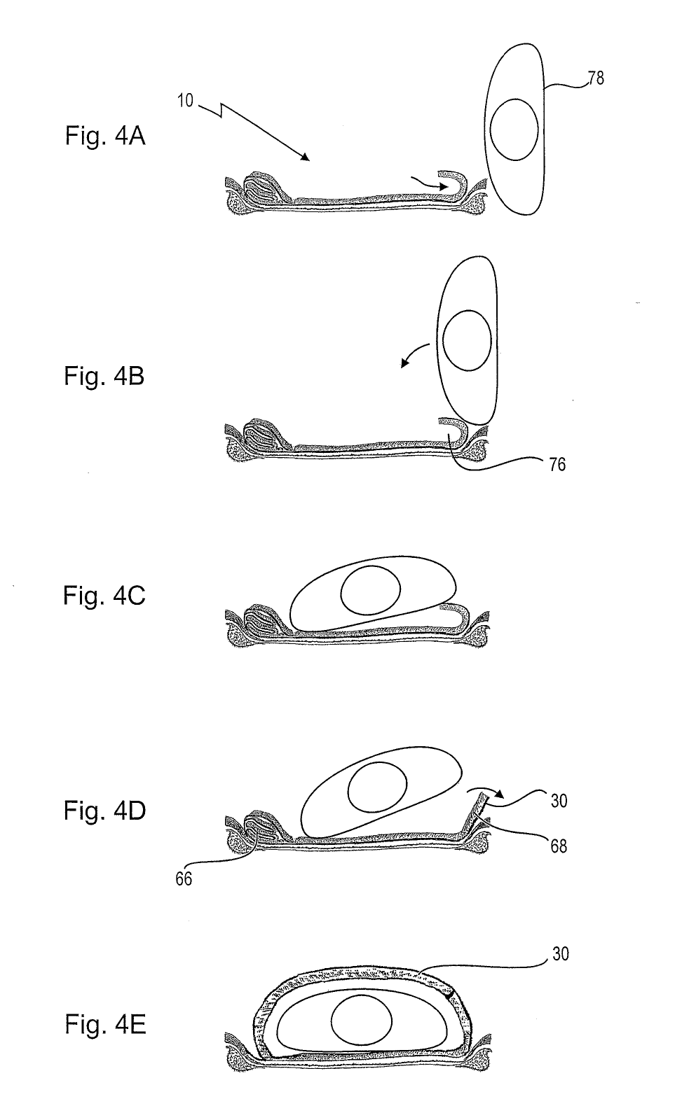

The procedure of placing the conveying device 10 on the patient is illustrated in detail in FIG. 4. In practice, the patient 78, who is in most cases initially lying on the ground, is brought into the stable side position (see FIG. 4A). The conveying device 10 is placed on the ground as close as possible to the patient. The helpers then try to push the conveying device 10 as far as possible underneath the patient 78 (see FIG. 4B). To do so, the helpers place their hands into the recess 76 and attempt to push the conveying device on the ground under the patient 78. Instead of the pocket-shaped recess 76, pulling belts are also conceivable, with the aid of which the conveying device 10 can be pulled under the patient 78.

As will be seen from FIG. 4C, the patient 78 is then turned about the longitudinal axis of his body, from the stable side position onto his back, such that he then comes to lie with his back on the lying surface 18. If the patient is not correctly positioned, or if he comes to lie on part of the cover sheet 30, the patient is then lifted again briefly, such that the concealed part of the cover sheet 30 can be folded out as shown in FIG. 4D. Both parts 66, 68 of the cover sheet 30 are then completely unfolded, and the patient 78 is dabbed clean with the cover sheet 30. The two parts of the cover sheet 30 are then connected to each other, such that they form a closed envelope around the patient 78 (see FIG. 4E). The patient can then be safely transported away. During transport, the rescue sheet 12 is lifted by means of the carrier grips 26 and, as has already been described above, detached from the covering underlay sheet 14. The covering underlay sheet 14 remains at the accident location in order to avoid the spread of contamination, while the rescue sheet 12, with the patient 78 lying on it, is carried away.

In summary, it may therefore be stated that the proposed portable conveying device has a high degree of mobility and, by virtue of its dimensionally flexible structure, can also be used on rough terrain. The novel conveying device proves particularly advantageous in accidents involving hazardous materials, which often result in patients being heavily soiled or being chemically, biologically or radioactively contaminated. By virtue of the two-part structure of the conveying device, the spread of contamination can be very substantially avoided, since the contaminated part (the covering underlay sheet) can be left behind at the accident location. At the same time, the part on which the patient is positioned (the rescue sheet) is protected by the first part (the covering underlay sheet) against contamination, such that the rescue sheet, together with the patient, can be carried away almost free of contamination. In addition, the novel portable conveying device affords the possibility of temporarily decontaminating the patient on site.

It will be appreciated that the design details in particular of the rescue sheet and of the covering underlay can deviate from the design shown in the illustrative embodiments, without thereby departing from the scope of the invention. The nature and form of the cover sheet may of course also be different.

What is claimed is:

1. A portable conveying device for patients who are heavily soiled or chemically, biologically or radioactively contaminated, comprising:
a rescue sheet having a mechanically flexible form, wherein said rescue sheet has a top face that defines a lying surface for receiving a patient in a lying position and an underside opposite the top face, facing away from the lying surface, wherein the rescue sheet is a multi-layer sheet having a liquid-absorbing absorber layer and a tear-resistant support layer that defines the underside of the support sheet; and
a covering underlay sheet having a mechanically flexible form and being chemically resistant and impermeable to liquid;
wherein the covering underlay sheet covers the underside of the rescue sheet and is releasably connected thereto, such that the covering underlay sheet may in its entirety be disconnected from the rescue sheet and a patient may be carried away with the rescue sheet only.

2. The portable conveying device as claimed in claim 1, wherein the releasable connection between the rescue sheet and the covering underlay sheet is realized by a plurality of connecting elements which are arranged at spaced-apart connection points at or near a peripheral outer edge of the rescue sheet and/or of the covering underlay sheet.

3. The portable conveying device as claimed in claim 2, wherein the plurality of connecting elements are connecting elements taken from the group of: press studs, hook-and-loop fasteners, zippers or releasable adhesive connections.

4. The portable conveying device as claimed in claim 1, wherein the top face of the rescue sheet defining the lying surface is additionally provided with a protective layer which is liquid-permeable and/or gas-permeable in an unidirectional manner to allow liquid and/or gas to penetrate into the absorber layer and to prevent the liquid and/or the gas from leaving the absorber layer through said protective layer.

5. The portable conveying device as claimed in claim 1, further comprising a chemical-resistant and/or temperature-resistant barrier layer that is arranged between the absorber layer and the tear-resistant support layer.

6. The portable conveying device as claimed in claim 1, further comprising a mechanically flexible, foldable cover sheet which, in a folded state, is fixed on the rescue sheet and, in an unfolded state, at least partially covers a patient positioned on the lying surface.

7. The portable conveying device as claimed in claim 6, wherein the cover sheet is a multi-layer sheet, with a second liquid-binding absorber layer and with a second protective layer which is liquid-permeable and/or gas-permeable permeable in an unidirectional manner to allow liquid and/or gas to penetrate into the second absorber layer and to prevent the liquid and/or the gas from leaving the second absorber layer through said second protective layer.

8. The portable conveying device as claimed in claim 6, wherein the cover sheet has a top face which, in the unfolded state, faces away from the patient positioned on the lying surface, said top face being provided with a liquid-repelling covering layer.

9. The portable conveying device as claimed in claim 6, wherein the cover sheet is designed in two parts, wherein the two parts of the cover sheet are each arranged on opposite lengthwise sides of the rescue sheet and are fixedly connected to the rescue sheet.

10. The portable conveying device as claimed in claim 9, wherein at least one of the parts of the cover sheet is turned over the lying surface on one of the lengthwise sides of the rescue sheet and thereby forms, with the lying surface, a pocket-shaped recess extending in a longitudinal direction of the rescue sheet.

11. The portable conveying device as claimed in claim 1, wherein an underside of the covering underlay sheet that faces away from the lying surface has a smooth surface made of plastic.

12. The portable conveying device as claimed in claim 1, wherein the covering underlay sheet has a peripheral outer edge and is at least partially surrounded at its outer edge by a liquid-absorbing and liquid-binding barrier element, wherein said barrier element has a bead-shaped design and comprises a nonwoven fabric.

13. The portable conveying device as claimed in claim 1, wherein the rescue sheet further comprises loops or eyelets through which a carrier frame for carrying the rescue sheet can be fitted releasably on the rescue sheet.

14. A portable conveying device for patients who are heavily soiled or chemically, biologically or radioactively contaminated, comprising:
a mechanically flexible rescue sheet, wherein said rescue sheet has a top face that defines a lying surface for receiving a patient in a lying position and an underside opposite the top face; and
a mechanically flexible underlay sheet that is chemically resistant and impermeable to liquid;
wherein the underlay sheet at least partially covers the underside of the rescue sheet and is releasably connected thereto, such that the underlay sheet may in its entirety be disconnected from the rescue sheet and a patient may be carried away with the rescue sheet only.

15. The portable conveying device as claimed in claim 14, wherein the rescue sheet is a multi-layer sheet having a liquid-absorbing absorber layer and a tear-resistant support layer that defines the underside of the support sheet.

16. The portable conveying device as claimed in claim 15, wherein the top face of the rescue sheet defining the lying surface is additionally provided with a protective layer which is liquid-permeable and/or gas-permeable in an unidirectional manner to allow liquid and/or gas to penetrate into the absorber layer and to prevent the liquid and/or the gas from leaving the absorber layer through said protective layer.

17. The portable conveying device as claimed in claim 15, further comprising a chemical- and temperature-resistant barrier layer that is arranged between the absorber layer and the tear-resistant support layer.

18. The portable conveying device as claimed in claim 1, wherein an underside of the underlay sheet that faces away from the lying surface has a smooth surface made of plastic.

19. The portable conveying device as claimed in claim 14, wherein the underlay sheet has a peripheral outer edge and is at least partially surrounded at its outer edge by a liquid-absorbing and liquid-binding barrier element, wherein said barrier element has a bead-shaped design and comprises a nonwoven fabric.

20. A portable conveying device for patients who are heavily soiled or chemically, biologically or radioactively contaminated, comprising:
a mechanically flexible rescue sheet, wherein said rescue sheet has a top face, that defines a lying surface for receiving a patient in a lying position, and an opposite underside, wherein the top face of the rescue sheet is provided with a protective layer which is liquid- and/or gas-permeable in an unidirectional manner, to allow liquid and/or gas to penetrate into an absorber layer that is arranged below the protective layer, and to prevent the liquid and/or the gas from leaving the absorber layer through said protective layer; and
a mechanically flexible underlay sheet that is impermeable to liquid;
wherein the underlay sheet at least partially covers the underside of the rescue sheet and is releasably connected thereto.
